(19) United States
(12) Patent Application Publication
(10) Pub. No.: US 2007/0254230 A1
(43) Pub. Date: Nov. 1, 2007

(54) EXTERNAL ADDITIVE COMPOSITION AND PROCESS

(75) Inventors: Juan A. Morales-Tirado, Rochester, NY (US); Daniel A. Harrington, Walworth, NY (US); William H. Hollenbaugh, Rochester, NY (US); Vladislav Skorokhod, Mississauga (CA); Wafa F. Bashir, Mississauga (CA); Jackie B. Parker, Mississauga (CA); Robert E. Grace, Fairport, NY (US); James M. Chappell, Webster, NY (US); Karen A. Moffat, Brantford (CA); Richard P.N. Veregin, Mississauga (CA); Cuong Vong, Hamilton (CA)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/426,502

(22) Filed: Jun. 26, 2006

Related U.S. Application Data
(60) Provisional application No. 60/745,946, filed on Apr. 28, 2006.

(51) Int. Cl. G03G 9/08

(52) U.S. Cl. 430/108.6; 430/137.14; 430/137.21; 430/108.7

(57) ABSTRACT

A process for toner preparation includes forming toner particles by mixing an emuslion comprising at least binder resin and a colorant, aggregating the toner particles, and blending external additives with the toner particles in a blender to form a toner, wherein the blender has a blend intensity of from about 90.5 to about 100.5 W/lb, a specific blend energy of from about 20.3 to about 35.3 W-h/lb and a blender loading density of from about 0.25 to about 0.55 lb/L.

### BACKGROUND

This disclosure relates generally to toners and developers containing toners. More particularly, the disclosure is directed to toners and developers having an external additive set achieved by a surface additive blending process. The resulting toners and developers provide superior image quality, improved admixing of toners into the developers, and reduced contamination levels in a printing and/or imaging application.

The toners and developers herein exhibit many advantages over conventional toners and developers, including for example reduction of background graininess, improvement in aging performance of the toners, which results in no image quality degradation over time, and reduction of contamination levels in a printing system such as a copy machine.

The toners and developers herein may be used in any printing and/or imaging application, including for example, electrophotographic, especially xerographic, imaging processes, printing processes, and including color and digital processes.

### REFERENCES

Toners and developers containing toners are essential components of any electrophotographic image forming system. In conventional electrophotographic image forming systems, an image is first projected onto a photoreceptor by performing a charging process and an exposure process. An electrostatic latent image is formed on the photoreceptor by first charging developers and then shifting the charged toner particles of the developers to the photoreceptor to develop the electrostatic latent image. Next, the developed electrostatic latent image is transferred onto a recording medium such as paper. Finally, a fixed electrostatic image is obtained by fusing the toners to the recording medium using heat, pressure and/or light.

One way for developing the electrostatic latent image is a one-component developing process using only a toner. Another way is known as a two-component developing process using a toner and a carrier. In the two-component developing process, the toner and the carrier are mixed to become electrically charged with opposite polarities through triboelectrification.

Emulsion aggregation toners may include acrylate based, for example, styrene acrylate, toner particles (see, for example, U.S. Pat. No. 6,5120,967, incorporated herein by reference in its entirety, as one example) or polyester, for example, sodio sulfonated polyester (see, for example, U.S. Pat. No. 5,916,725, incorporated herein by reference in its entirety, as one example).

U.S. Pat. No. 5,922,501 describes a process for the preparation of toner comprising blending an aqueous colorant dispersion and a latex resin emulsion, and which latex resin is generated from a dimeric acrylic acid, an oligomer acrylic acid, or mixtures thereof and a monomer; heating the resulting mixture at a temperature about equal, or below about the glass transition temperature (Tg) of the latex resin to form aggregates; heating the resulting aggregates at a temperature about equal to, or above about, the Tg of the latex resin to effect coalescence and fusing of the aggregates; and optionally isolating the toner product, washing, and drying.

U.S. Pat. No. 5,462,828 describes a toner composition that includes a styrene/n-butyl acrylate copolymer resin having a number average molecular weight of less than about 5,000, a weight average molecular weight of from about 10,000 to about 40,000 and a molecular weight distribution of greater than 6 and provides excellent gloss and high fix properties at a low fusing temperature.

A known way of developing the latent image on the photoreceptor is by use of one or more magnetic brushes. See, for example, U.S. Pat. Nos. 5,416,566, 5,345,298, 4,465,730, 4,155,329 and 3,981,272, each incorporated herein by reference.

In a conductive magnetic brush system, toner is removed from the system when fed onto a recording medium, such as paper, in permanently generating an image on the recording medium. As a result, additional toner must be introduced into the conductive magnetic brush system to generate more images.

However, fresh toner prior to addition into the system may not have a charge. Thus, the toner needs to be charged to the opposite polarity of the carrier in a two-component developer. For example, if the carrier is positively charged, the toner needs to be negatively charged to properly transfer the toner onto the recording medium. If the toner has lower charge than the aged toner or it has an incorrect polarity (wrong sign toner), the toner may undesirably print in the background, resulting in image quality degradation.

U.S. Pat. No. 6,319,647 describes a toner of toner particles containing at least one binder, at least one colorant, and preferably one or more external additives that is advantageously formed into a developer and used in a magnetic brush development system to achieve consistent, high quality copy images. The toner particles, following triboelectric contact with carrier particles, exhibit a charge per particle diameter (Q/D) of from 0.6 to 0.9 fC/μm and a triboelectric charge of from 20 to 25 μC/g. The toner particles preferably have an average particle diameter of from 7.8 to 8.3 microns. The toner is combined with carrier particles to achieve a developer, the carrier particles preferably having an average diameter of from 45 to 55 microns and including a core of ferrite substantially free of copper and zinc coated with a coating comprising a polyvinylidenefluoride polymer or copolymer and a polymethyl methacrylate polymer or copolymer.

U.S. Pat. No. 6,878,499 describes a process for making a toner. The process includes mixing a toner resin and a colorant; extruding the resin and colorant mixture; attritting the resin and colorant mixtures; classifying the attritted particles into particles averaging 4 to about 10 microns in size; and blending sufficient surface additive particles and the classified particles in a high intensity blender such that the weight of attached surface additives is greater than two of the weight of the classified particles and such that the blending is intense enough to yield Additive Adhesion Force Distribution percent values after 10 minutes of signification and 12 kilojoules of energy greater than 40 percent.

### SUMMARY

What is desired is a toner and a developer containing the toner, that may be advantageously used in magnetic brush development systems, which are able to produce excellent print quality in varying temperature and humidity environments and over a long period of time without image quality degradation. In addition, it is also desired to add fresh toner as an admixture into an aged developer substantially without generating toner that has wrong sign polarity.

Also described herein are the aspects of toners and developers that operate in a conductive magnetic brush development environment to achieve image qualities that are superior to known toners and developers, and the aspects of a blending process to mix the toner with external additives under blending conditions that result in improved toner functionality such as providing substantial charge stability of the toner with a unimodal charge distribution and minimum relative humidity sensitivity. Moreover, minimum toner contamination inside a printing apparatus such as a copy machine may be achieved with the use of the toners produced by the blending process conditions.

In embodiments, described is a process for toner preparation, comprising forming toner particles by mixing an emulsion comprising at least binder resin and a colorant, aggregating the toner particles, and blending external additives with the toner particles in a blender to form the toner, wherein the blender has a blend intensity value of from about 90.5 to about 100.5 W/lb, a specific blend energy value of from about 20.3 to about 35.3 W-h/lb and a blender loading density of from about 0.25 to about 0.55 lb/L.

In embodiments, a toner is described that is comprised of toner particles of at least one binder, at least one colorant, and external additives, wherein the external additives include a first silica comprising about 1.54% to about 1.88% by weight of the toner particles, a second silica differing at least in an average diameter from the first silica and an optional third silica and comprising about 0.67% to about 0.82% by weight of the toner particles, the optional third silica, when present, comprising about 0.23% to about 0.55% by weight of the toner particles, and a titania comprising about 0.99% to about 1.22% by weight of the toner particles.

In still farther embodiments, a developer is described that comprises a carrier and a toner, wherein the toner comprises toner particles of at least one binder, at least one colorant, and external additives, and wherein the external additives include a first silica comprising about 1.54% to about 1.88% by weight of the toner particles, a second silica differing at least in an average diameter from the first silica and an optional third silica and comprising about 0.67% to about 0.82% by weight of the toner particles, the optional third silica, when present, comprising about 0.23% to about 0.55% by weight of the toner particles, and a titaria comprising about 0.99% to about 1.22% by weight of the toner particles.

### EMBODIMENTS

Electrophotographic printing processes generally involve charging a photoconductive member such as a photoreceptor to a substantially uniform potential in order to sensitize the surface thereof. The charged portion of the photoconductive member is then exposed to a light image to reproduce an original document by a scanning laser beam, an LED source and the like. Exposure of the charged photoconductive member causes the level of electrical charge on the photoconductive member surface to change and results in an electrostatic latent image being recorded on the photoconductive member. After the electrostatic latent image is recorded on the photoconductive member surface, the latent image is developed by bringing a developer material comprising toner particles adhering to carrier granules triboelectrically into proximity therewith. The toner particles are then repelled from the carrier granules and/or attracted to the latent image and adhered to the electrostatic latent image, thereby forming a toner powder image on the photoconductive member. The toner powder image is subsequently transferred from the photoconductive member to a recording medium such as a sheet of paper. Eventually, the toner powder image is heated through a fusing process to permanently affix the toner particles to the sheet of paper.

Enabling good image quality from a printing apparatus such as a copy machine, delivering good image quality over a long period of time, and minimizing toner contamination inside a printing apparatus may be some of the most pressing issues in the printing industry. The toners, developers and blending processes described herein enable improvement in one or more of these properties.

This disclosure describes the aspects of toners and developers that may be used in a conductive magnetic brush development environment. A conductive magnetic brush system herein includes any conductive magnetic brush systems, for example including a semi-conductive magnetic brush development system. The use of the toners and developers herein in such conductive magnetic brush systems achieve superior image quality over known toners and developers.

Embodiments of a toner include toner particles of at least one binder, at least one colorant, and external additives, wherein the external additives include a first silica comprising about 1.54% to about 1.88% by weight of the toner particles, a second silica comprising about 0.67% to about 0.82% by weight of the toner particles, an optional third silica, when present, comprising about 0.23% to about 0.55% by weight of the toner particles, and titania comprising about 0.99% to about 1.22% by weight of the toner particles. In embodiments, the toner particles may have an average particle diameter of from about 3 to about 15 μm, for example from about 5 to about 13 μm or from about 5 to about 10 μm.

Any suitable resin binder for use in toner may be employed. Toners prepared by chemical methods such as emulsion/aggregation (E/A) may particularly be used, although toners prepared by physical methods such as grinding may also be employed. Specific suitable toner examples are as follows.

The binder may be a styrene/acryiate binder, for example such as known in the art. Styrene/acrylate binder containing toner particles created by the EA process are illustrated in a number of patents, the disclosures of each of which are incorporated herein by reference in their entirety, such as U.S. Pat. Nos. 5,278,020, 5,290,654, 5,308,734, 5,344,738, 5,346,797, 5,364,729, 5,370,963, 5,403,693, 5,418,108, and 5,763,133. The styrene/acrylate binder may comprise any of the materials described in the aforementioned references.

Illustrative examples of styrenelacrylates include known polymers selected from the group consisting of styrene acrylates, styrene methacrylates, butadienes, isoprene, acrylonitrile, acrylic acid, methacrylic acid, beta-carboxy ethyl acrylate, polyesters, poly(styrene-butadiene), poly(methyl styrene-butadiene), poly(methyl methaerylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethlyl acrylate-isoprene), poly(propyl acrylate-isoprene), poly(butyl acrylate-isoprene); poly(styrene-propyl acrylate), poly(styene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styene-butyl acrylate-acrylonitriIe-acrylic acid), and styrene/butyl acrylate/carboxylic acid terpolyners, styrene/butyl acrylate/beta-carboxy ethyl acrylate terpolymers, PLIOTONE™ available from Goodyear, and mixtures thereof.

The binder resin selected, such as styrene acrylates, styrene butadienes, styrene methacrylates, and the like, may be present in various effective amounts, such as from about 50 weight percent to about 98 weight percent, and more specifically, about 55 weight percent to about 75 weight percent or about 70 weight percent to about 95 weight percent, based upon the total weight percent of the toner particles. Other effective amounts of resin may be selected. The resin may be of small average particle size, for example from about 0.01 μm to about 3 μm, such as from about 0.05 μm to about 2 μm or from about 1.5 μm to about 2.5 μm in average volume diameter as measured by the Brookhaven nanosize particle analyzer.

The styrene/acrylate binder may comprise, for example, a styrene:butyl acrylate:beta-carboxy ethyl acrylate, wherein, for example, the monomers are present in an amount of about 40% to about 95% styrene, about 5% to about 60% butyl acrylate, and about 0.05 parts per hundred to about 10 parts per hundred beta-carboxy ethyl acrylate; or about 60% to about 85% styrene, about 15% to about 40% butyl acrylate, and about 1 part per hundred to about 5 parts per hundred beta-carboxyetliyl acrylate, by weight based upon the total weight of the monomers.

Colorants may be pigments, dye, mixtures of pigment and dyes, mixtures of pigments, mixtures of dyes, and the like. Various known colorants, such as pigments, may be present in the toner in an amount of, for example, from about 1 to about 25 percent by weight of toner, such as in an amount of from about 3 to about 10 percent by weight or from about 5 to about 20 percent by weight.

Examples of suitable colorants for making toners include carbon black such as REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600 ™, 8610 ™; Northern Pigments magnetites, NP-604™, NP-608™; Magnox magnetites TMB-100™, or TMB-104™; and the like. As colored pigments, there can be selected, for example, various known cyan, magenta, yellow, red, green, brown, blue colorants or mixtures thereof. Specific examples of pigments include phthalocyanine HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E. I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan, magenta, yellow components may also be selected as pigments. The colorants, such as pigments, selected can be flushed pigments as indicated herein. Colorant examples further include Pigment Blue 15:3 having a Color Index Constitution Number of 74160, Magenta Pigment Red 81:3 having a Color Index Constitution Number of 45160:3, and Yellow 17 having a Color Index Constitution Number of 21105, and known dyes such as food dyes, yellow, blue, green, red, magenta dyes, and the like.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YUD 600X and 9604X (Pigment Yellow 14 21095), FLEXIVERSE LFD 4343 and LFD 9736 (Pigment Black 7 77226) and the like or mixtures thereof. Other useful water based colorant dispersions commercially available from Clariant include HOSTAFINE Yellow GR, HOSTAFINE Black T and Black TS, HOSTAFINE Blue B2G, HOSTAFINE Rubine F6B and magenta dry pigment such as Toner Magenta 6BVP2213 and Toner Magenta E02, which can be dispersed in water and/or surfactant prior to use.

Furthermore, the toner compositions may also include suitable waxes, for example as a release agent. Suitable waxes include, for example, polypropylenes and polyethylenes commercially available from Allied Chemical and Petrolite Corporation; EPOLENE N-15™ commercially available from Eastman Chemical Products, Inc.; VISCOL 550-P™, a low weight average molecular weight polypropylene available from Sanyo Kasei K.K.; mixtures thereof, and the like. The commercially available polyethylenes selected possess, for example, a weight average molecular weight of from about 500 to about 5,000, for example from about 500 to about 2,500 or from about 1,000 to about 1,500, while the commercially available polypropylenes utilized are believed to have a weight average molecular weight of from about 4,000 to about 7,000, for example from about 4,000 to about 6,000 or from about 4,500 to about 5,500. Many of the polyethylene and polypropylene compositions are illustrated in British Patent No. 1,442,835, the entire disclosure of which is incorporated herein by reference.

The wax may be present in the toner composition in various amounts. However, generally these waxes are present in the toner composition in an amount of from about 5 percent by weight to about 25 percent by weight, for example in an amount of from about 5 percent by weight to about 15 percent by weight or from about 8 percent by weight to about 10 percent by weight, based on the weight of the toner composition.

External additives are additives that associate with the surface of the toner particles. In embodiments, the external additives include at least a first silicon dioxide or silica (SiO₂), a second silica, and a titania or titanium dioxide (TiO₂).

In general, silica is applied to the toner surface for toner flow, triboelectric enhancement, admix control, improved development and transfer stability and higher toner blocking temperature. TiO₂ is applied for improved relative humidity (RH) stability, triboelectric control and improved development and transfer stability.

In embodiments, the first silica is applied to the toner surface for toner flow, tribo enhancement, admix control, improved development and transfer stability and higher toner blocking temperature. TiO₂ is applied for improved relative humidity (RH) stability, triboelectric control and improved development and transfer stability. The second silica is applied to reduce toner cohesion, stabilize the toner transfer efficiency, reduce/minimize development falloff characteristics associated with toner aging, and stabilize triboelectric charging characteristics and charge through. The second silica external additive particles have a larger average size (diameter) than the first silica, and thus for example have an ultra large particle size as discussed below, and are present on the surface of the toner particles, thereby functioning as spacers between the toner particles and carrier particles and hence reducing the impaction of smaller conventional toner external surface additives such as the first silica and/or titania during aging in the development housing. The spacers thus stabilize developers against disadvantageous burial of conventional smaller sized toner external additives by the development housing during the imaging process in the development system. The ultra large external additives, such as the aforementioned second silica, function as a spacer-type barrier, and therefore the smaller conventional toner external additives of, for example, silica and titania, are shielded from contact forces that have a tendency to embed them in the surface of the toner particles. The ultra large external additive particles thus provide a barrier and reduce the burial of smaller sized toner external surface additives, thereby rendering a developer with improved flow stability and hence excellent development and transfer stability during copying/printing in xerographic imaging processes. The toner compositions exhibit an improved ability to maintain their DMA (developed mass per area on a photoreceptor), their TMA (transferred mass per area from a photoreceptor) and acceptable triboelectric charging characteristics and admix performance for an extended number of imaging cycles.

In addition, an optional third silica is applied to the toner surface to improve toner flow and to increase triboelectric charge of the toner while the first silica is applied to the toner surface for toner flow, tribo enhancement, admix control, improved development and transfer stability and higher toner blocking temperature and the second silica acts as spacer-type barrier to shield the smaller conventional toner external additives of such as the first silica, the optional third silica and titania from contact forces that have a tendency to embed them in the surface of the toner particles. Moreover, the optional third silica external additive particles have a smaller average size (diameter) than the first silica and the second silica, and are present on the surface of the toner particles, thereby functioning as flow aids to enhance toner flow.

In embodiments, the first silica, the second silica, the optional third silica and the titania may each have an average primary particle size of less than 200 nm. The first silica may have an average primary particle size, measured in diameter, in the range of, for example, from about 5 nm to about 50 nm, such as from about 5 nm to about 95 nm or from about 20 nm to about 40 nm. The second silica may have an average primary particle size, measured in diameter, in the range of, for example, from about 100 nm to about 200 nm, such as from about 100 nm to about 150 nm or from about 125 nm to about 145 nm. The optional third silica may have an average primary particle size, measured in diameter, in the range of, for example, from about 1 nm to about 20 nm, such as from about 2 nm to about 10 nm or from about 5 nm to about 15 nm. The titania may have an average primary particle size in the range of, for example, about 5 nm to about 50 nm, such as from about 5 nm to about 20 nm or from about 10 nm to about 50 nm. Of course, larger size particles may also be used, if desired, for example up to about 500 nm. Titania is found to be especially helpful in maintaining development and transfer over a broad range of area coverage and job run length.

The first silica, the second silica, the optional third silica and the titania may be applied to the toner surface with the total coverage of the toner ranging from, for example, about 20% to about 90% surface area coverage (SAC), such as from about 20% to about 60% or from about 45% to about 85%. Another metric relating to the amount and size of the additives is “SAC×Size” ((percentage surface area coverage) times (the primary particle size of the additive in nanometers)), for which the additives may have a total SAC×Size range between, for example, about 500 to about 4,000, such as from about 1000 to about 3000 or from about 500 to about 1500.

In embodiments, the first silica may be surface treated with polydimethylsiloxaiie. Such a treated silica is commercially available as RY50 from Nippon Aerosil. The second silica may be untreated silica, such as sol-gel silicas. Examples of such sol-gel silicas include, for example, X24, available from Shin-Etsu Chemical Co., Ltd. The third silica may be surface treated fumed silicas such as TS530, commercially available from Cabot Corporation, Cab-O-Sil Division. The titania may be either treated or untreated. Untreated titania is available as P25 from Degussa. In embodiments, the titania is surface treated, for example with a decylsilane which is commercially available as MT3103, or as SMT5103, both available from Tayca Corporation.

The first silica may be present in the toner particles in amounts of, for example, from about 1.54% to about 1.88% by weight of the toner particles, such as from about 1.54% to about 1.65% or from about 1.6% to about 1.8% by weight of the toner particles. The second silica may be present in the toner particles in amounts of, for example, from about 0.67% to about 0.82% by weight of the toner particles, such as about 0.67% to about 0.7% or about 0.7% to about 0.8% by weight of the toner particles. The optional third silica may be present in the toner particles in the amounts of, for example, from about 0.23% to about 0.55% by weight of the toner particles, such as about 0.25% to about 0.35% or about 0.3% to about 0.5%. The titania may be present in the toner particles in amounts of, for example, from about 0.99% to about 1.22% by weight of the toner particles, such as about 1% to about 1.2% or from about 0.99% to about 1.1% by weight of the toner particles.

It is desirable that toners and developers be functional under a broad range of environmental conditions to enable good image quality from a printer. Thus, it is desirable for toners and developers to function at low humidity and low temperature, for example at 16° C. and 20% relative humidity (denoted herein as J-zone), at moderate humidity and temperature, for example at 21° C. and 50% relative humidity (denoted herein as B-zone), and high humidity and temperature, for example at 27° C. and 80% relative humidity (denoted herein as A-zone).

For good performance under a broad range of conditions, critical properties of the toner and developer should change as little as possible across environmental zones described as A-zone, B-zone and J-zone, If there is a large difference across these zones, the materials may have a large relative humidity (R-H) sensitivity ratio, which means that the toner may show performance shortfalls in the extreme zones, either at low temperature and humidity, or high temperature and humidity, or both. A goal for critical properties is for the RH sensitivity ratio to be as close to one as possible. When such an RH sensitivity ratio is achieved, the toner may be equally effective in both high humidity and low humidity conditions. Stated another way, the toner has low sensitivity to changes in RH.

In order to improve the charging behavior and to provide improved performance of the toner in a print apparatus such as a copy machine, an effective external additive package may be formulated and associated with the surface of the toner particles. Triboelectric charge/toner concentration (TC) latitude space refers herein as an ideal operating space confined by a range of triboelectric charge and a range of TC latitude. An ideal operating space for toner particles with an external additive package, having triboelectric contact with carrier particles, may exhibit a triboelectric charge of, for example from about 25 μC/g to about 47 μC/g, such as from about 25 μC/g to about 35 μC/g or from about 30 μC/g to 45 μC/g, and a TC range for example, from about 2.5% to about 4%, such as from about 2.5% to about 3% or from about 3% to about 4%. Denoting triboelectric charge as the Y-axis and TC as the X-axis results in an ideal toner developer operating space of a box shape having a width ranging from about 25 μC/g to about 47 μC/g and a length from about 2.5% to about 4%. This ideal operating space defines the functional xerographic space for optimum development performance generating excellent image quality of fusing prints from a conductive magnetic brush development system.

In embodiments, a toner developer includes a 40 nm RY50 silica with a mass of about 1.71% by weight of the toner particles, a 140 nm X24 silica with a mass of about 0.74% by weight of the toner particles, a 8 nm TS530 silica with a mass of about 0.36% by weight of the toner particles, and a 40 nm JMT2000 titania with a mass of about 1.11% by weight of the toner particles. The SAC for the toner developer is 84%. The triboelectric charges of the toner developer in A-Zone are in the range of from about 22 μC/g to about 33 μC/g. The triboelectric charges of the toner developer in J-Zone are in the range of from about 25 μC/g to about 36 μC/g. Hence, the RH sensitivity, a ratio of J-Zone triboelectric charge to A-Zone triboelectric charge is, for example, from about 1.1 to about 1.3, such as about from 1.09 to about 1.14, and thus, the ratio of J-Zone triboelectric charge to A-Zonie triboelectric charge is close to the ideal value of 1, indicating the toner developer has low RH sensitivity.

In addition to the low RH sensitivity shown by the toner, it also demonstrates excellent aging performance. Normally, the triboelectric charge of the toner would be degraded as the toner material ages over time. The reasons for the degradation of the triboelectric charge of the toner material over time are at least twofold. First, there may be some removal of the surface coating from the carrier, and second, there may also be some level of transferring of the external additives from the toner to the carrier while both the toner and carrier are mixed together to generate the triboelectric charge. Thus, as the characteristics of the carrier change over time, the triboelectric charge of the toner is reduced. One way to evaluate for toner aging characteristics is to place toner in an aging fixture such as Northstar. The fixture is essentially a paperless pump that accelerates the aging of the toner and develops the toner onto a photoreceptor belt. The toner developers, in embodiments, were aged for 190 hours in the fixture. During the period of 190 hours, triboelectric charges were measured at 1, 5, 7, 10, 15, 20, 40, 45, 50, 60, 80, 100, 130, 150 and 170 and 190 hours, and the corresponding triboelectric charges were 33, 30, 26, 32, 28, 30, 24, 27, 27, 23, 25, 29, 33, 32 and 31 μC/g, respectively. Thus, the aging test of the toner material shows that the triboelectric charge of the toner remains stable and stays within a narrow range from about 23 to about 33 μC/g, and shows no substantial degradation over the 190-hour period.

Hence, in embodiments, a toner comprising toner particles of at least one binder, at least one colorant, and external additives such as discussed herein may provide several improved toner functionalities. These may include, for example, (1) adequate charge level with triboelectric charges in the operating range of from about 25 μC/g to about 47 μC/g, (2) charge stability by maintaining triboelectric charge values ranging form about 23 to about 33 μC/g during the aging performance of 190 hours, and, (3) excellent RH sensitivity by having RH sensitivity of from about 1.1 to about 1.3.

Furthermore, the way in which the toner is blended with the external additives may also play a role in making the toner having the aforementioned improved toner functionalities. A blending process is a process where external additives are associated with toner particles in a blender. One embodiment of a process for toner preparation includes forming toner particles by mixing an emulsion comprising at least binder resin and a colorant, aggregating the toner particles to a desired size, and blending external additives with the toner particles in a blender to form the toner, wherein the external additives include the additive package described above comprised of a first silica, a second silica, an optional third silica and titania. The external additives are typically added to the toner particles in a blender such as a Henschel Blender FM-10, 75 or 600 blender. The blending serves to break additive agglomerates into the appropriate nanometer size, evenly distribute the smallest possible additive particles within the toner batch, and associate the smaller additive particles with the toner particles. Each of these processes occurs concurrently within the blender.

The amount of time used for the blending process determines how much energy is applied during the blending process. The energy applied during the blending process herein may be represented by specific blend energy. Specific blend energy may be expressed as W-h/lb. Specific blend energy is defined as the product of the specific power consumption by the mass inside the blender and the total blend time. The specific power consumption by the mass inside the blender is defined as the difference in power draw between the loaded and empty blender divided by the mass inside the blender (blend intensity). The power draw is determined at the operating blend tool speed and is recorded from the equipment panel. The blend time, in embodiments, may be in the range of from 5 minutes to 30 minutes, such as from 15 minute to 20 minutes or from 10 minutes to 25 minutes. The corresponding specific blend energy may be from about 20.3 to about 35.3 W-h/lb, more specifically from about 24.3 to about 31.3 W-h/lb, or from about 30.3 to about 35.3 W-h/lb, during the blending process to produce toners with the aforementioned improved toner functionalities.

During the blending process, additive particles become attached to the surface of the toner particles when collisions occur between particles, and between the particles and the blender tool as it rotates. It is believed that such attachment between toner particles and surface additives occurs due to both mechanical impaction and electrostatic attractions. The amount of such attachments is proportional to the intensity level of blending which, in turn, is a function of both the speed and shape (particularly size) of the blending tool. Blend intensity refers to, for example, the rate of flow of energy used for blending a specific mass of toner particles having the external additive package attached thereto. The blend intensity may be effectively measured by reference to the power per unit mass, which is typically expressed as W/lb. Because the blend intensity relates to the rate of flow of energy, the speed at which the blender rotates determines the intensity level of the blender. The higher the speed, the more intense the blending becomes. In embodiments, the speed of the rotating blender generally exceeds about 80 ft/s, for example from about 80 ft/s to about 120 ft/s, such as from about 80 ft/s to about 110 ft/s or from about 90 ft/s to about 100 ft/s. The blend intensity may be effectively measured by reference to the power expressed in watts (A,) (a measure of the rate in time at which work is done on a system) per unit mass, which is typically expressed as W/lb. The blend intensity can be determined as the difference in power draw between the loaded and empty blender divided by the mass inside the blender. The power draw is determined at the operating blend tool speed and is recorded from the equipment panel. Thus, in order to achieve the aforementioned improved toner functionalities, the corresponding blend intensity may have a value of, for example, from about 90.5 to about 100.5 W/lb, more specifically from about 95.5 to about 99.5 W/lb, or from about 93.5 to about 97.5 W/lb.

The strength of attachment of the additives is described by a metric called Additive Attachment Force Distribution (AAFD). This metric reports the relative amount of specific additives remaining on the toner particles' surface after a toner suspension is sonicated under different levels of energy. Specifically, the initial concentration of the specific additive on the surface of the toner particles is determined by an analytical technique such as Inductively Coupled Plasma Optical Emission Spectroscopy or Energy-Dispersive X-Ray Fluorescence Spectroscopy. Then, a sample, for example of about 7 to about 10 g of toner, is used to produce an aqueous dispersion of toner particles. A surfactant, such as Triton-X, may be added to wet the toner particles and maintain the uniform dispersion of the toner particles in the aqueous media. A sonic probe is then inserted into the toner dispersion and the sample is sonicated for a desired length of time, for example from 10 seconds to 10 minutes or more, to deliver a predetermined amount of energy to the toner and causing a fraction of the additive to detach from the toner particles' surface. The dispersion is then let to rest, allowing the toner particles to settle at bottom of the dispersion container and the additives to migrate to near the surface of the aqueous media. The supernatant is then removed from the aqueous media and the amount of the additive in the supernatant is measured by an Inductively Coupled Plasma Optical Emission Spectroscopy. A percentage of the additive remaining on the surface of the toner particles (AAFD) can then be calculated based on the initial additive concentration on the surface of the toner particles before sonication and the amount of the additive removed from the surface of the toner particles after sonication. In embodiments where one or more silica are included as the external surface additive, the toners herein may exhibit an AAFD, with respect to the total amount of silica, of from about 20% to about 90% such as from about 20% to about 75% or from about 25% to about 50% for a sonification energy of 12 kilo Joules (KJ) and from about 50% to about 90% such as from about 50% to about 85% or from about 50% to about 75% for a sonification energy of 6 KJ.

The amount of toners loaded into a blender may also affect the toner functionalities. The amount of toners that are loaded into a blender may be expressed in term of a blender loading density of the toners. Blender loading density herein refers to the amount of toners as expressed in pound (lb) loaded into the blender at a volume of 1 liter (L). More specific, the blender loading density is defined as the mass of toner particles inside the blender divided by the volume of the blender. In embodiments, the blender loading density may be in the range of, for example, from about 0.25 to about 0.40 lb/L, more specifically from about 0.25 to 0.35 lb/L or from about 0.23 to about 0.33 lb/L.

The aforementioned blending process with blending conditions and the resulting toner produced by the blend process may also have an effect on the adequacy of admixing of the toners. Adequate admix refers for example to a state in which freshly added toner rapidly gains charge to the same level of the incumbent toner (toner that is present in the developer prior to the addition of fresh toner) in the developer. Thus, ideally, the incumbent toner and the fresh toner may have the same charge rate and thus have a unimodal charge distribution. When freshly added toner fails to rapidly charge to the level of the incumbent toner already in the developer, a situation known as slow admix occurs, and two distinct charge levels exist side-by-side in the development subsystem, and hence resulting in a bimodal charge distribution. In some cases, freshly added toner that has no net charge may be available for development onto the photoreceptor.

In embodiments, when the toner produced by the blending process according to the present disclosure is admixed to the incumbent toner in the development subsystem, however, a substantially unimodal charge distribution results for both the fresh toner and the incumbent toner, as measured by a charge spectrograph. For example, conventional toner compositions often exhibit charge distributions that have a distinct second peak below the primary peak in the charge distribution. In contrast, according to embodiments of the present disclosure, the toner can be produced having a substantial unimodal charge distribution and very little, or substantially no, low charge or wrong sign toner as measured by a charge spectrograph.

According to embodiments, the charge spectrograph analyses of the toners exhibit improved charge distribution over conventional toners. That is, it has been found that in toner compositions including the first silica, second silica, optional third silica and titania with the specific formulation as illustrated herein provide a substantially unimodal charge distribution as compared to toner compositions without the specific additive package. Stated another way, on a charge distribution plot, toners compositions herein exhibit a single primary peak to achieve a substantially unimodal charge distribution. The toners herein thus provide further improvement in the adjustment of charge distribution for a toner composition.

The toner described herein may be mixed with a carrier to achieve a two-component developer composition. The toner concentration in each developer may range from, for example, about 1 to about 10%, such as about 2 to about 6% or about 2.5% to about 4% by weight, of the total weight of the developer.

Toner particles may be used in forming a developer by mixing with one or more carrier particles. Carrier particles that can be selected for mixing with the toner include, for example, those carriers that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Additionally, there can be selected as carrier particles nickel berry carriers as disclosed in U.S. Pat. No. 3,847,604, the entire disclosure of which is hereby incorporated herein by reference, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326, the disclosures of which are hereby incorporated herein by reference. In embodiments, the carrier may comprise atomized steel having a size of about 80 μm. In embodiments, the carrier particles may have an average particle size of from, for example, about 40 to about 85 μm, such as from about 40 to about 80 μm or from about 55 to about 85 μm. The carrier particles may also have a conductivity of from about 10⁻⁸ to about 10⁻⁶ (ohm-cm)⁻¹, such as from about 10⁻⁸ to about 10⁻⁷ (ohm-cm)⁻¹ or from about 10⁻⁷ to about 10⁻⁶ (ohm-cm)⁻¹.

The selected carrier particles can be used with or without a coating, the coating, generally being comprised of fluoropolymers, such as polyvinylidene fluoride resins, terpolymers of styrene, methyl methacrylate, a silane, such as triethoxysilane, tetrafluoroethylenes, other known coatings and the like. The carrier core is preferably at least partially coated with a polymethyl methacrylate (PMMA) polymer having a weight average molecular weight of 300,000 to 350,000 commercially available from Soken. The PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like.

The developer composition may be included in an electrostatographic/xerographic device such as an electrophotographic image forming apparatus in order to form an image upon an image receiving member such as a photoreceptor. An embodiment of an electrophotographic image forming apparatus includes a photoreceptor, a conductive magnetic brush development system, and a housing in association with the conductive magnetic brush development system and containing the developer. A conductive magnetic brush development system advances the developer material into contact with the electrostatic latent image. The conductive magnetic brush development system may include a magnetic brush in the form of a rigid cylindrical sleeve, which rotates around a fixed assembly of permanent magnets. The cylindrical sleeve may be made of an electrically conductive, non-ferrous material such as aluminum or stainless steel, with its outer surface textured to control developer adhesion. The rotation of the sleeve transports magnetically adhered developer material comprising carrier granules (particles) and toner particles and allows direct contact between the developer brush and a belt having a photoconductive surface. The electrostatic latent image attracts the toner particles from the carrier granules forming a toner power image on the photoconductive surface of the belt. In embodiments, a conductive magnetic brush development system may be a semiconductive magnetic brush development system. During operation of the apparatus, without adequate attachment and distribution of additives to the toner surface, the toner particles may separate from the carrier particles as a result of collisions between these particles, and the components of the imaging apparatus. Therefore, when toner particles without adequate additive attachment are mixed with the carrier particles to form developers to be used in the imaging apparatus, the force of collision with the imaging components overcomes the binding force existing between the toner and carrier particles, causing the carrier particles to become detached from the toner particles. The resulting free toner particles are then caused to move within the system and after a period of time deposit on various components of the imaging apparatus causing contamination thereof and causing the components to change their characteristics over a period of time. This contamination adversely affects image quality wherein in many instances images of low resolution result.

However, when toner particles are blended with external additives having a first silica, a second silica, optional third silica and titania using a blender having a blend intensity of from about 90.5 to about 100.5 W/lb, a specific blend energy of from about 20.3 to about 35.3 W-h/lb and a blender loading density of from about 0.25 to 0.55 lb/L, the contamination in the imaging apparatus may be reduced. As shown in Table 1 below, specific blend energy has a significant impact on reducing contamination in the imaging apparatus. The magnitude of contamination is measured by comparing a resulting contamination level against a visual rating scale called a Standard Image Reference (SIR). Based on this scale, a lower number indicates less contamination. Specifically, as the specific blend energy increases, the system contamination level as denoted by the SIR rating drops sharply, from about 20 to about 17. Furthermore, as the specific blend energy increases, the white deposits contamination level denoted by the SIR also drops sharply, from about 3.9 to about 0. The values of the Additive Attachment Force Distribution, expressed as % silica remaining, system contamination, and contamination due to white deposits were determined for the range of the desirable blending conditions. These values are summarized in Table 1 as set forth below.

TABLE 1
Comparison Of Additive Attachment Force Distribution
And Contamination Magnitude

| Specific | | % Silica | % Silica | | |
|---|---|---|---|---|---|
| Blend | Blend | Remaining (6K | Remaining (12K | | |
| Energy | Intensity | Joules of Energy) | Joules of Energy) | System | White |
| (W-h/lb) | (W/lb) | (AAFD) | (AAED) | Contamination | Deposits |
| 20.3 | 90.5 | 44 | 19 | 20 | 3.9 |
| 20.3 | 100.5 | 44 | 19 | 20 | 3.9 |
| 35.3 | 90.5 | 53 | 30 | 17 | 0 |
| 35.3 | 100.5 | 53 | 30 | 17 | 0 |

For Table 1, a toner composition was prepared by blending an external additive package having 1.71% RY50 Silica, 0.74% X24 Silica, 0.36% TS530 Silica, and 1.11% JMT2000 Titania into a set weight of toner particles in a Henschel FM Blender at different levels of Blend Energy and Blend Intensity. The resulting toner compositions showed different levels of Additive Attachment Force Distribution, system contamination, and white deposits.

During operation of the apparatus, the collisions between toner/carrier particles and the components of the imaging apparatus may also result in the detachment of external additives when the external additives are not sufficiently attached to toner particles, that is, when the external additives have strength deficiencies. The free external additives called white deposits may then deposit on various components of the imaging apparatus causing contamination thereof. However, the white deposits in the imaging apparatus may be reduced when toner particles are blended with external additives having a first silica, a second silica, optional third silica, and titania using a blender having a blend intensity value of from about 90.5 to about 100.5 W/lb, a specific blend energy value of from about 20.3 to about 35.3 W-h/lb and a blender loading density of from about 0.25 to 0.55 lb/L. A measurement of the strength at which the additives are attached to the toner particles' surface demonstrates that the strength of the external additives may increase as the amount of specific blend energy in the blend process increases. By way of example, as shown in Table 1, as the amount of specific blend energy increases, the strength of the attachment of external additives, expressed as percentage of the total silica remaining on the toner particles' surface (AAFD), that is, the percent of the first silica, the second silica and the optional third silica combined, increases from about 44% to about 53% for a sonification energy of 6 kilo Joules (KJ). In addition, as shown in Table 1, as the amount of specific blend energy increases, the strength of the external additives, expressed as percentage of the total silica remaining on the toner particles' surface (AAFD), increases from about 19% to about 30% for a sonification energy of 12 kilo Joules (KJ). Moreover, higher percentage silica remaining on the toner particles' surface indicates stronger additive attachment strength. Thus, increased specific blend energy results in a significant improvement of the attachment strength of the external additives to the toner particles, which in turn may reduce the level of system contamination and white deposits in the imaging apparatus. Stated another way, the level of contamination in the imaging apparatus may be reduced when toner particles are associated with external additives having a first silica, a second silica, optional third silica, and titania using a blender having a blend intensity value of from about 90.5 to about 100.5 W/lb, a specific blend energy value of from about 20.3 to about 35.3 W-h/lb and a blender loading density of from about 0.25 to about 0.55 lb/L.

Furthermore, the image quality of an image reproduced onto a recording medium such as paper may be improved as a result of the toner particles associated with external additives having a first silica, a second silica, optional third silica, and titania using a blender having a blend intensity value of from about 90.5 to about 100.5 W/lb, a specific blend energy value of from about 20.3 to about 35.3 W-h/lb and a blender loading density of from about 0.25 to about 0.55 lb/L. Image quality may be characterized by image quality metrics such as lightness, mottle, and graininess, all of which are dimensionless parameters. Lightness is a measure of an image transition from black to white at a given toner per mass area. Toner per mass area may be expressed as mg/m². Mottle is a measure of how much lightness changes within the print of the reproduced image. In an electrophotographic system, graininess is usually found in and caused by the development subsystem, while mottle is caused by an incomplete transfer of toner to substrate. In embodiments, the reproduced image resulting from the toner particles associated with external additives having a first silica, a second silica, optional third silica, and titania using a blender having a blend intensity value of from about 90.5 to about 100.5 W/lb, a specific blend energy value of from about 20.3 to about 35.3 W-h/lb and a blender loading density of from about 0.25 to about 0.55 lb/L may have image quality metrics that include a lightness having a range of from, for example about 19 to about 26, such as from about 19 to about 22 or from about 20 to about 25, a mottle value having a range of generally less than about 40, for example from about 0 to 40, such as from about 28 to about 38 or from about 25 to about 35, and a graininess value having a range of generally less than 2, for example from about 0 to about 2, such as from about 0.5 to about 1.5 or from about 0.9 to about 1.9, for a given toner mass per area having a range of less than about 0.6 mg/m², for example from about 0 to about 0.6 mg/m², such as from about 0.2 mg/m² to about 0.5 mg/m² or from about 0.01 to about 0.55 mg/m². These image quality metrics demonstrate that by associating toner with the aforementioned external additive package and by using a blender having a blend intensity value of from about 90.5 to about 100.5 W/lb, a specific blend energy value of from about 20.3 to about 35.3 W-h/lb and a blender loading density of from about 0.25 to 0.55 lb/L, the image quality may be improved.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A process for toner preparation comprising:
forming toner particles by mixing an emulsion comprising at least binder resin and a colorant,
aggregating the toner particles, and
blending external additives with the toner particles in a blender to form a toner, wherein the blender has a blend intensity of from about 90.5 W/lb to about 100.5 W/lb, a specific blend energy of from about 20.3 W-h/lb to about 35.3 W-h/lb and a blender loading density of from about 0.25 lb/L to about 0.55 lb/L.

2. The process of claim 1, wherein the external additives include at least a first silica, a second silica and an optional third silica, and wherein a percent of the first silica, the second silica and the optional third silica remaining on the toner particles is from about 50% to about 90% following application of a sonification energy of 6 kilo Joules or from about 20% to about 90% following application of a sonification energy of 12 kilo Joules.

3. The process of claim 1, wherein the blending is from about 5 minutes to about 30 minutes.

4. The process of claim 1, wherein the blending is at a speed from about 80 ft/s to about 120 ft/s.

5. The process of claim 1, wherein the external additives include at least a first silica, a second silica, an optional third silica and a titania, wherein the first silica is about 1.54% to about 1.88% by weight of the toner particles, the second silica is about 0.67% to about 0.82% by weight of the toner particles, the optional third silica, when present, is about 0.23% to about 0.55% by weight of the toner particles, and the titania is about 0.99% to about 1.22% by weight of the toner particles.

6. A toner comprising toner particles of at least one binder, at least one colorant, and external additives, wherein the external additives include a first silica comprising about 1.54% to about 1.88% by weight of the toner particles, a second silica differing at least in an average diameter from the first silica and an optional third silica, and comprising about 0.67% to about 0.82% by weight of the toner particles, the optional third silica, when present, comprising about 0.23% to about 0.55% by weight of the toner particles, and a titania comprising about 0.99% to about 1.22% by weight of the toner particles.

7. The toner of claim 6, wherein the first silica is about 1.71% by weight of the toner particles, the second silica is about 0.74% by weight of the toner particles, the optional third silica, when present, is about 0.36% by weight of the toner particles, and the titania is about 1.11% by weight of the toner particles.

8. The toner of claim 6, wherein the toner particles further comprises a wax dispersion as a release agent.

9. The toner of claim 8, wherein the wax dispersion is present in an amount of about 5% to about 25% by weight of the toner particles.

10. The toner of claim 6, wherein the at least one binder is an emulsion aggregation styrene/acrylate binder.

11. The toner of claim 6, wherein the toner particles have a triboelectric charge relative humidity sensitivity ratio of from about 1.1 to about 1.3.

12. The toner of claim 6, wherein the first silica has an average diameter of from about 5 nm to about 50 nm and the optional third silica has an average diameter of from about 1 nm to 20 nm.

13. The toner of claim 6, wherein the second silica has an average diameter of from about 100 nm to about 200 nm.

14. The toner of claim 6, wherein the titania has an average diameter of from about 5 nm to about 50 nm.

15. A developer comprising a carrier and a toner, wherein the toner comprises toner particles of at least one binder, at least one colorant, and external additives, and wherein the external additives include a first silica comprising about 1.54% to about 1.88% by weight of the toner particles, a second silica differing at least in an average diameter from the first silica and an optional third silica and comprising about 0.67% to about 0.82% by weight of the toner particles, the optional third silica, when present, comprising about 0.23% to about 0.55% by weight of the toner particles, and a titania comprising about 0.99% to about 1.22% by weight of the toner particles.

16. The developer of claim 15, wherein the toner particles further comprises a wax dispersion as a release agent.

17. The developer of claim 16, wherein the wax dispersion is present in an amount of about 5% to about 25% by weight of the toner particles.

18. The developer of claim 15, wherein the toner has a triboelectric charge of from about 25 μC/g to about 47 μC/g.

19. An electrophotographic image forming apparatus comprising a photoreceptor, a conductive magnetic brush development system, and a housing in association with the conductive magnetic brush development system and containing a developer according to claim 15, wherein images formed by the apparatus have a toner mass per area having a range of from about 0 to about 0.6 mg/m², a lightness having a range of from about 19 to about 26, a mottle value having a range of from about 0 to about 40 and a graininess value having a range of from about 0 to about 2.

20. The electrophotographic image forming apparatus of claim 19, wherein the conductive magnetic brush development system is a semi-conductive magnetic brush development system.
